(19) United States
(12) Patent Application Publication
(10) Pub. No.: US 2017/0279292 A1
(43) Pub. Date: Sep. 28, 2017

(54) MULTIMODE OPERATION OF WIRELESS POWER SYSTEM WITH SINGLE RECEIVER

(71) Applicant: INTEL CORPORATION, SANTA CLARA, CA (US)

(72) Inventors: Hooman SHIRANI-MEHR, Portland, OR (US); Ahmad KHOSHNEVIS, Portland, OR (US)

(21) Appl. No.: 15/082,049

(22) Filed: Mar. 28, 2016

(51) Int. Cl. H02J 7/02; H02J 50/80; H02J 50/12

(52) U.S. Cl. CPC H02J 7/025; H02J 50/12; H02J 50/80

(57) ABSTRACT

Wireless charging, such as that conducted according to various industry standards for wireless charging, can be conducted by magnetic resonance (MR) and/or magnetic induction (MI). Systems, devices, and methods herein provide management of dual mode recharging where a power transmitter unit (PTU) can provide power to charge a power receiver unit (PRU) by MR, MI or both MR and MI. To management the dual mode recharging, the PTU completes handshakes for both modes then determines the abilities of the PRU. Based on the PRU, the PTU selects the MR mode, the MI mode, or a dual mode (using both MR and MI charging). In dual mode, the PTU can use MR and MI charging simultaneously or alternate between the MR and MI modes.

### TECHNICAL FIELD

This application generally relates to wireless charging. In particular, this application relates to wireless charging as described in protocols generated by and for the AirFuel™ Alliance and/or other various industry standards for wireless charging.

### BACKGROUND

Mobile devices, such as mobile phones and laptops, require power that is generally supplied by batteries. Typically, the batteries are recharged by plugging the device into an outlet to receive power. New developments in providing wireless power, through an electromagnetic have been expanding. Unfortunately, these wireless power interfaces have the ability to interfere with other tasks performed by the mobile devices, such as the transmission of data through a radio frequency interface.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a representation of a wireless charging environment;

FIG. 2 is a block diagram illustrating an embodiment of a wireless charging system including at least one a power transmitter unit (PTU) and at least one a power receiver unit (PRU);

FIG. 3 is a block diagram illustrating embodiments of a PRU and PTU;

FIG. 4A is data diagram chart illustrating an embodiment of a long beacon sent by a PTU to a PRU;

FIG. 4B is another data diagram chart illustrating an embodiment of a PRU advertisement that may be sent by a PRU to a PTU;

FIG. 4C is another data diagram chart illustrating an embodiment of a static and dynamic parameters exchanged between a PTU and a PRU;

FIG. 4D is another data diagram chart illustrating an embodiment of a an accept/reject message that may be sent by a PTU to a PRU;

FIG. 4E is another data diagram chart illustrating an embodiment of a digital ping that may be sent by a PTU to a PRU;

FIG. 4F is another data diagram chart illustrating an embodiment of a receive identifier (RXID) message that may be sent by a PRU to a PTU;

FIG. 5 is a signal diagram of signals exchanged between the PRU(s) and PTU;

FIG. 6 is a flowchart illustrating an embodiment of a method for conducting multi-mode wireless charging between a PTU and a PRU;

FIG. 7A is a flowchart illustrating an embodiment of a method for conducting multi-mode wireless charging between a PTU and a PRU;

FIG. 7B is a flowchart illustrating an embodiment of a method for conducting multi-mode wireless charging between a PTU and a PRU;

FIG. 8A is a flowchart illustrating an embodiment of a method for conducting multi-mode wireless charging between a PTU and a PRU;

FIG. 8B is a flowchart illustrating an embodiment of a method for conducting multi-mode wireless charging between a PTU and a PRU;

FIG. 9A is a flowchart illustrating an embodiment of a method for conducting multi-mode wireless charging between a PTU and a PRU;

FIG. 9B is a flowchart illustrating an embodiment of a method for conducting multi-mode wireless charging between a PTU and a PRU; and

FIG. 10 is a block diagram illustrating components of a mobile device.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DESCRIPTION OF EMBODIMENTS

Embodiments herein are generally directed to wireless charging and wireless charging systems. Various embodiments are directed to wireless charging performed according to one or more wireless charging standards. Some embodiments may involve wireless charging performed according to interface standards developed by Rezence, the AirFuel™ Alliance, and/or other various industry standards for wireless charging. Various embodiments may involve wireless charging performed using the 6.78 MHz industrial, scientific, and medical radio (ISM) band.

Charging Environment:

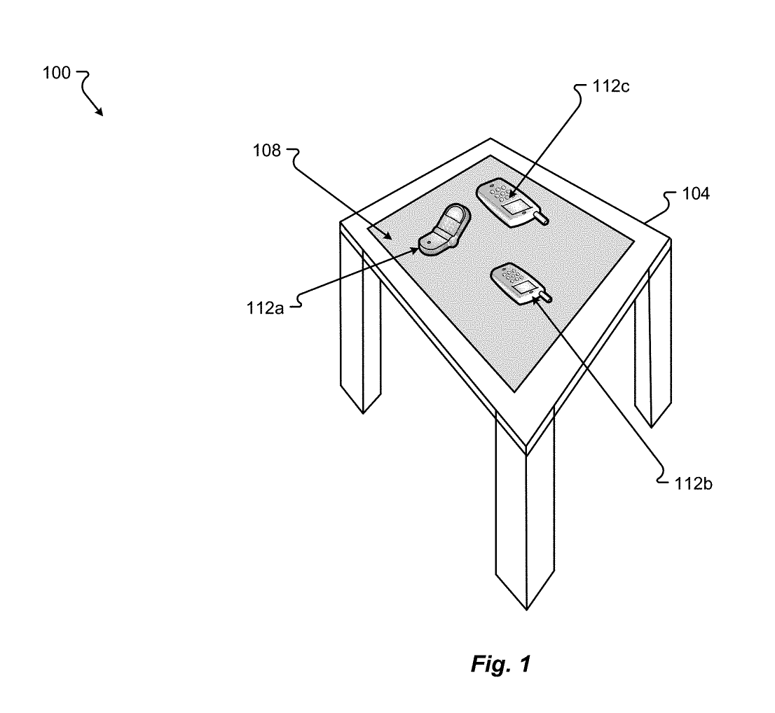

An embodiment of a system 100 for conducting wireless charging may be as shown in FIG. 1. The system 100 can include a platform 104 that can charge one or more mobile devices 112a through 112c positioned on a wireless charging base 108. The platform 104, while shown as a table, can be any type of surface that can hold the mobile device 112 while charging on the wireless charging area 108.

The platform 104 may have an electrical connection between the wireless charging area 108 and an electrical source such as a connection to the power grid. The power provided to the wireless charging area 108 may be then be provided through inductive or wireless charging from the wireless charging area 108 to one or more mobile devices. Thus, the wireless charging area 108 may include one or more coils that produce an electromagnetic field to provide an electromagnetic charge in a coil within the mobile device 112. The wireless charging area 108 can include a power transfer unit (PTU) that can provide resident charging to a power receiving unit (PRU) resident in each of one or more mobile devices 112.

Wireless Charging System:

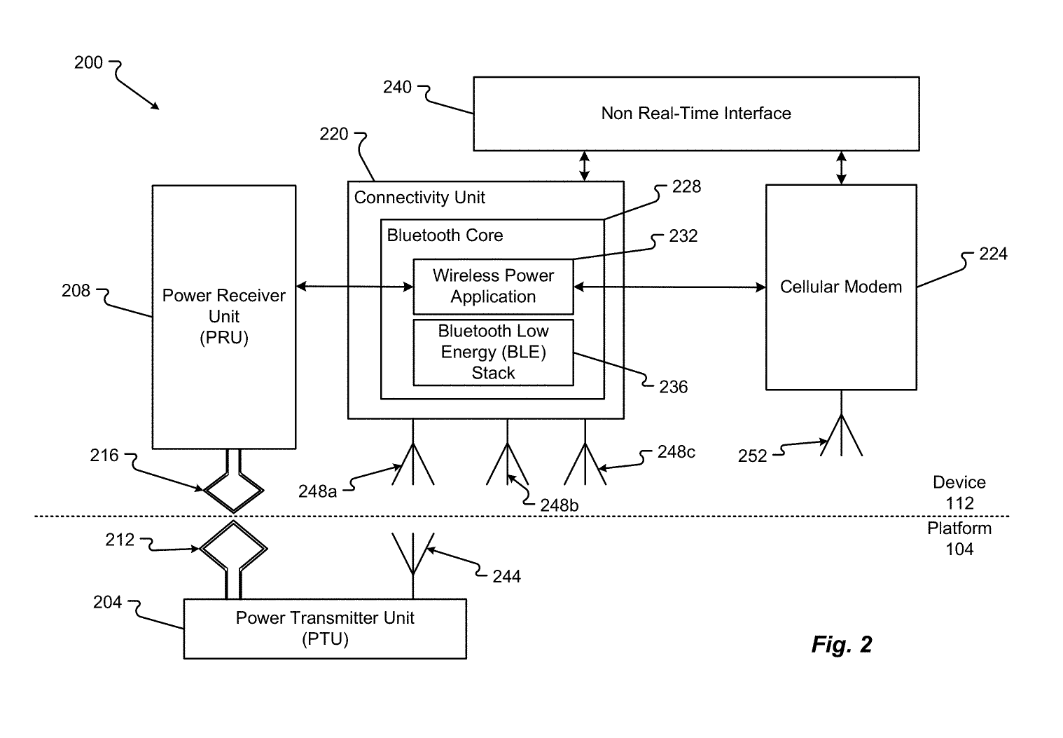

An embodiment of a charging system 200 that performs wireless charging between a platform 104 and a device 112 is shown in FIG. 2. In the charging system 200, the platform 104 may include a power transmitter unit (PTU) 204 electrically coupled to a coil 212. A mobile device 112 can include a Power Receiver Unit (PRU) 208 electrically coupled to a coil 216 that can convert the electromagnetic field generated by coil 212 into a current that may be provided to the PRU 208. The PTU 204 may be disposed within the charging platform 104, while the PRU 208 may be disposed within the mobile device 112.

The PTU 204 contains all the electronics to enable power to be taken from power supply, convert the power into a format that can be used by the PRU 208 to enable the PRU 208 to be charged. The PTU 204 can include any type of circuits, devices, interconnections, etc. that can convert an electrical current from a power source to an electromagnetic field for charging the mobile device. The PRU 208 can include any electronics, processing, power connections, etc. required to be able to receive the electromagnetic field from the PTU 204 and convert that electromagnetic energy into a current that may be used to charge a battery or provide power to one or more electronics within the mobile device 112.

The PRU 208 may be connected to a connectivity unit 220 that includes one or more electronic devices or hardware used to communicate by and/or through one or more protocols. The connectivity unit 220 can include, for example, one or more, but is not limited to, a Bluetooth® Core 228 for use with communications using the Bluetooth® standard to the PTU 204. The Bluetooth® Core 228 may be able to send signals through antennae 248a, 248b, and/or 248c to communicate with the PTU 204 that will receive a signal on antennae 244. While a Bluetooth® is shown and described herein, the PTU 204 and PRU 208 may communicate through other interfaces and protocols, and Bluetooth® is only one example of the types of interfaces that may be used.

The Bluetooth® Core 228 can include a Bluetooth® Low Energy (BLE) stack 236. The Bluetooth® Core 228 may communicate through the BLE protocol and standard with the PTU 204. Included within the Bluetooth® Core 228 may also be an wireless power application 232. The wireless power application 232 can provide control to the PRU 208, may receive communications or signals from the device processor or controller, the cellular modem 224, the PRU 208, and/or communicate with the BLE stack 236 to communicate changes to the charging protocol conducted by the PTU 204.

The cellular modem 224 can include any type of hardware and/or software used to communicate through a cellular protocol or network via antennae 252. Thus, the cellular modem 224 conducts communications for the mobile device 112 to conduct its primary purpose of communicating data back and forth from the mobile device 112 to other devices or systems. The cellular modem 112 can interface with a non-real-time interface 240 that can send information or communications to the connectivity unit 220. Thus, the non-real-time interface 240 may communicate with the connectivity unit 220 through channel interfaces different than the connection to the wireless power application 232.

Power Transmitter Unit and Power Receiver Unit:

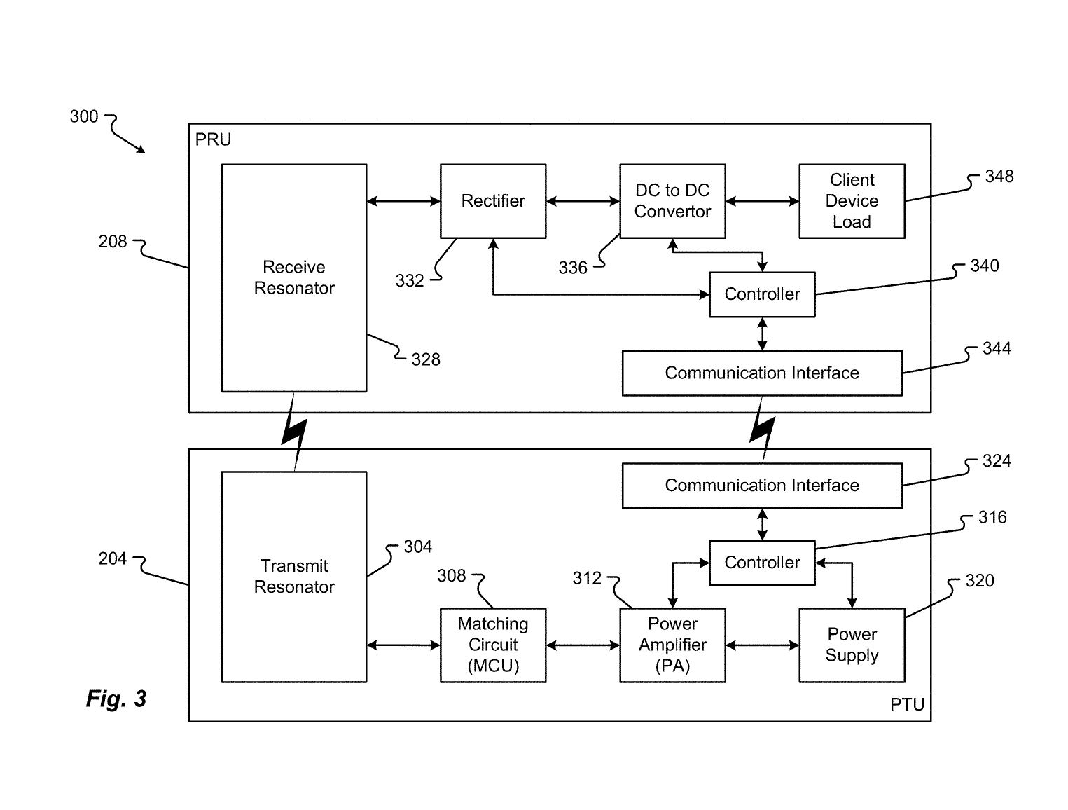

Additional or alternative embodiments of the PTU 204 and the PRU 208 may be as shown in the system 300 provided in FIG. 3. The PTU 204 may include one or more hardware or software components. For example, the PTU 204 can include one or more of, but is not limited to, a transmit resonator 304, matching circuit (MCU) 308, power amplifier (PA) 312, power supply 320, a controller 316 and a BLE communication interface 324.

The transmit resonator 304 can provide the resonating frequency through the coil 212 to produce the electromagnetic field that charges the PRU 208. The transmit resonator 304 may be a hardware unit connected to a matching circuit 308. The matching circuit 308 can create the proper resident frequency for the transmitter resonator 304, which may be 6.78 MHz. Thus, the matching circuit 308 can include one more of, but is not limited to, capacitors, resistors, frequency generators, etc. to create the proper resonant frequency over the inductive coil 212. Further, the matching circuit 308 may be in connection or electrically coupled to the transmit resonator 204 and the power amplifier 312.

The power amplifier 312 can be in communication with the controller 316 and the power supply 320. The power amplifier 312 may include any kind of amplification circuitry used to amplify the voltage of the alternating current (AC) power signal being sent to the matching circuit 308. The power amplifier 312 can increase the voltage of the AC power signal from the power supply 320.

The power supply 320 may obtain power from a power source, such as the power grid, may convert that power from DC to AC or do other operations to provide an AC power signal to the power amplifier 312. The power supply 320 may be in communication with the controller 316.

The controller 316 may be any type of processor or controller operable to execute commands or instructions that may be provided in firmware and/or software. The controller 316 may communicate these instructions to other circuitry, such as the power amplifier 312 or the power supply 320. Further, the controller 316 may be in communication with the BLE communication interface 324 to communicate instructions or receive signals from the PRU 208 of the mobile device 112. The BLE communication interface 324 can be any hardware and/or software used to transmit a wireless signal using the BLE protocol and antennae 244 to send a signal to the BLE stack 236 of the PRU 208 in the mobile device 112.

The PRU 208 may also include hardware and software used to receive power to charge a battery or provide power to different loads in the mobile device 112. These hardware/software components may include one or more of, but is not limited to, a receive resonator 328, a rectifier 332, a DC to DC converter 336, a controller 340, a BLE communication interface 344, and/or a client device load 348.

The receive resonator 328 may include any hardware or circuitry to receive the resonating AC electromagnetic field and convert that into a AC current signal in the PRU 208. For example, the receive resonator 328 can include one or more of, but is not limited to, capacitors, resistors, matching circuitry, etc. to receive a resonating AC frequency from the PTU 204. The receive resonator 328 may then communicate the AC current to the rectifier 332.

The rectifier 332 can include one or more diodes to convert the AC current signal into a direct current (DC). The rectifier 332 may change the rectification based on instructions from the controller 340, and thus, the rectifier 332 is in communication with the controller 340.

This DC power signal may then be transmitted to the DC to DC converter 336 from the rectifier, which can modify the amplitude or other characteristics of the DC power signal. Thus, the DC to DC converter 336 can contain any hardware or other circuitry required to modify the DC signal. The conditioned DC signal may then be sent from DC to DC converter 336 to the client device load 348. The client device 348 can include any electronics used by the connectivity unit 220, cellular modem 224, or other components as described in conjunction with FIG. 11. Further, the battery of the mobile device 112 may be included as part of the client device load 348.

The controller 340 may be similar to the controller 316 in that the controller 340 may include any type of processor, hardware, and/or software used to execute instructions, receive communications, or do other operations to control the PRU 208. Thus, the controller 340 may command or instruct the rectifier 332, the DC to DC converter 336, or the other components within the PRU 208 to change the operating characteristics of the PRU 208 based on requirements.

The BLE communication interface 334 may be similar to the BLE communication interface 324 in that the BLE communication interface 334 may exchange signals using the BLE protocol with the BLE communication interface 324.

Data Structures and Data Communications:

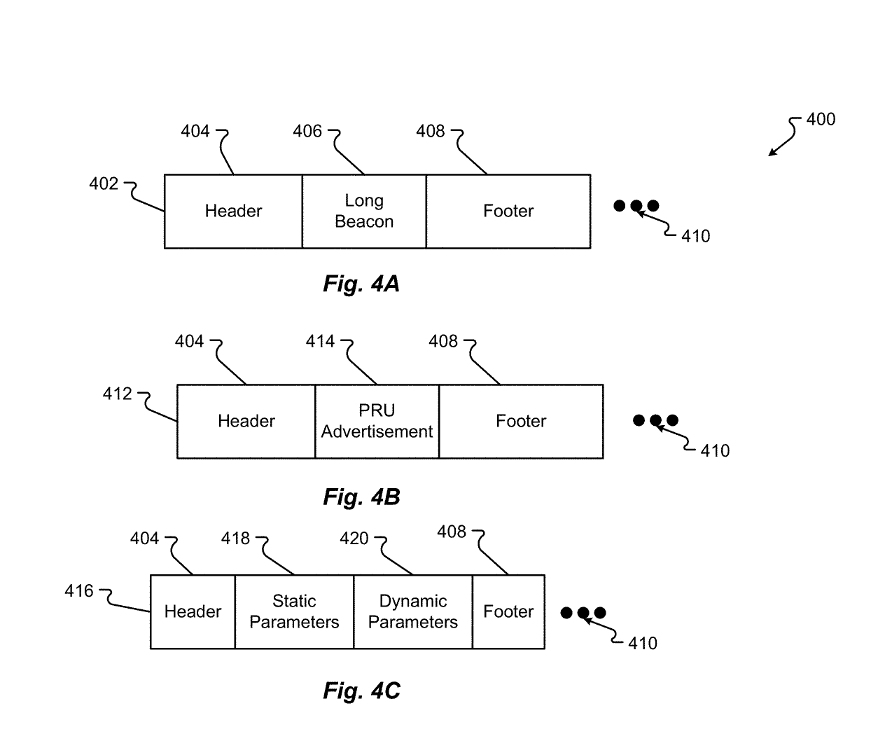

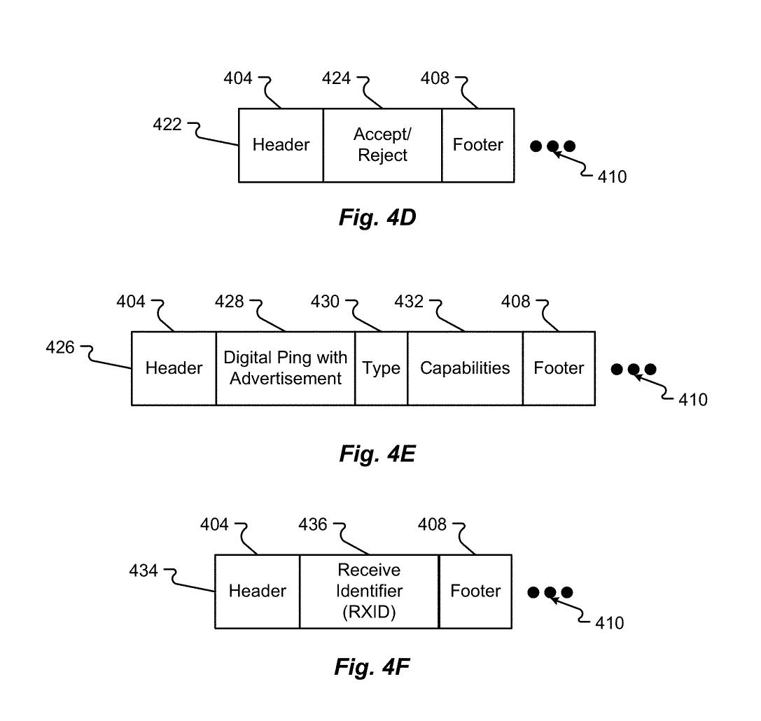

To conduct the multi-mode wireless charging operations between the PTU 204 and PRU 208, one or more communication data packets may be exchanged between the PRU 208 and the PTU 204, as shown in FIGS. 4A through 4F. In some configurations, these data packets may include instructions or information and may be exchanged using a communications protocol, hardware, and/or software associated with, for example, the BLE interfaces 324, 344. Thus, each of these data packets 402, 412, 416, 422, 426, and/or 434, as shown in FIGS. 4A thru 4F, can include a header 404 and footer 408, which represent the package wrapper to communicate data using the communication interface format and protocol. However, these signals 402, 412, 416, 422, 426, and/or 434 may be sent in any type of wireless format. The header 404 and footer 408 comprise one or more items of information to generally arrange, organize, and/or manage the parameters that follow in the other portions of data structures 402, 412, 416, 422, 426, and/or 434. Thus, some or all of the information within the header portion 404 or footer portion 408 may accompany a transmission of a portion or an entirety of the other information in portions of messages 402, 412, 416, 422, 426, and/or 434. The signals 402, 412, 416, 422, 426, and/or 434 may have more or fewer fields than those shown in FIGS. 4A-4F as represented by ellipses 410.

An embodiment of a long beacon 402 which may be sent from the PTU 204 to one or more PRUs 208 to indicate that the PTU 204 can conduct MR charging is as shown in FIG. 4A. The long beacon 402 may have a long beacon field 406, which can include a bit or byte indicating that MR charging is possible. The long beacon field 406 allows the PRU 208 to respond as to whether MR charging or the MR mode is desired or possible for the PRU 208.

An embodiment of a response 412, to the long beacon 402, may be as shown in FIG. 4B. The response 412 can include a PRU advertisement field 414. The PRU advertisement field 414 can include the one or more characteristics or parameters of the PRU 208 that are associated with MR charging with the PRU 208. The characteristics in the PRU advertisement 414 allow the PTU 204 to determine if the PRU 208 is capable of conducting MR charging and/or desires to conduct MR charging. These characteristics can include a type of PRU 208, an indication whether MR charging is possible, a listing or types of components provided in the PRU 208, etc.

An embodiment of a data structure 416 that may exchange parameters between the PTU 204 and PRU 208 may be as shown in FIG. 4C. The parameters 416 can include static parameters 418 and dynamic parameters 420. Static parameters 418 can include those characteristics/parameters of either the PTU 204 or the PRU 208 which do not change. For example, the static parameters 418 can include an identification or identifier for the PTU 204, PRU 208, a type or model of the PRU 208 or PTU 204, or other types of unchangeable parameters that are associated with MR charging, which need to be exchanged between the PTU 204 and the PRU 208.

The dynamic parameters 420 can include any parameter that may change or adjust for either the PTU 204 or PRU 208. These dynamic parameters 420 can include characteristics of the MR charging environment, including capable voltages, frequencies, etc., matching circuit abilities, or other types of information that either the PTU 204 or PRU 208 may adjust for MR charging.

An embodiment of an accept/reject decision 422, from the PTU 204, may be as shown in FIG. 4D. This decision data structure 422 may include an accept field and/or a reject field 424. In some situations, the accept or reject 424 is a single bit that when set is an acceptance, and if not set, is a rejection. In other configurations, the accept field and/or reject field 424 may be more than one bit to indicate whether the PTU 204 accepts the PRU 208 for MR charging.

An embodiment of a digital ping signal 426, which may be sent from the PTU 204 to one or more PRUs 208, to determine if MI charging is possible may be as shown in FIG. 4E. The digital ping signal 426 may include one or more fields that indicate the capabilities of the PTU 204 for MI charging. These fields can include one or more of, but are not limited to, a digital ping with advertisement field 428, a type field 430, a capabilities field 432, etc.

The digital ping with advertisement field 428 can be one or more indicator bits that indicate to the PRU 208 that the PTU 204 can conduct MI charging. As such, the indicator advertises the PTUs ability to conduct MI charging. If the message 426 does not include a separate capabilities field 432, the capabilities for the MI charging can be included in the digital ping with advertisement field 428 with or in place of the indicator bit(s).

The type field 430 can be any bit or bits that indicate what type of MI charging the PTU 204 can conduct. The type 430 can be a descriptor of some type of hardware, software, or protocol used by the PTU 204. In alternative or additional configurations, the PTU 204 may indicate a characteristic of the MI charging that indicates a type 430. Thus, the PTU 204 may indicate a frequency, voltage, etc., used for MI charging.

The capabilities field 432 can describe how the PTU 204 can conduct MI charging. The capabilities 432 may provide a range for characteristics or adjustments the PTU 204 can make for MI charging. For example, the capabilities can include frequencies or voltage ranges, can include availability of load with the PTU 204, and/or can include other information that allows the PRU 208 to determine if MI charging is possible with the PTU 204.

A response 434, send by the PRU 208, to the digital ping 426 may be as shown in FIG. 4F. The response 434 can include a receive identifier (RXID) field 436 that can indicate that MI charging is possible with the PRU 208 and/or desired by the PRU 208. As with the digital ping 426, the RXID 436 may include other information about the PRU 208 including the capabilities of the PRU 208 that are associated with MI charging. Thus, the RXID field 436 may include on or more of, but is not limited to, a range for characteristics or adjustments the PRU 208 can make for MI charging (such as frequencies or voltage ranges), how much load the PRU 208 may require, and/or can include other information that allows the PTU 204 determine if MI charging is possible with the PRU 208.

Data Signalling:

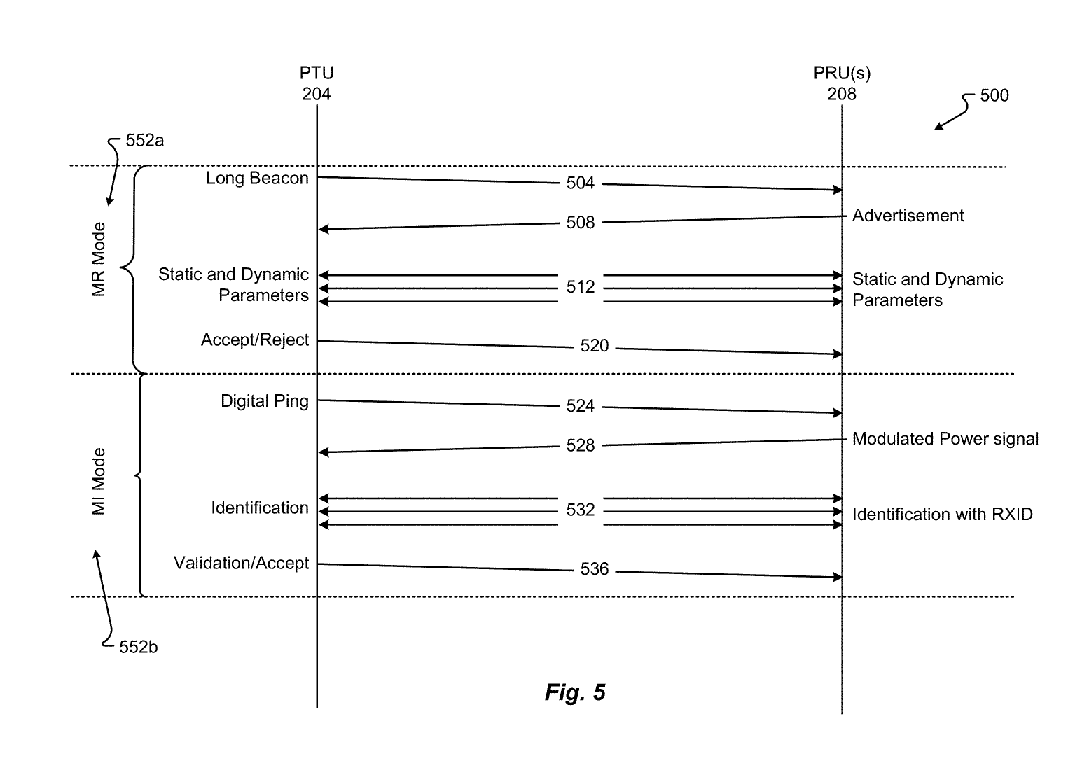

An embodiment of a signal diagram 500 may be as shown in FIG. 5. The signal diagram 500 shows an exchange of communications between the PTU 204 and PRU(s) 208 regarding entering a MR mode for wireless charging and/or a MI mode for wireless charging. The MR mode may be as shown in section 552a, with the MI mode shown in section 552b.

The MR mode 552a may start with the transmission of the long beacon signal 504 from the PTU 204 to the PRU 208. The long beacon 504 may be the same or similar to signal 402, as described in conjunction with FIG. 4A. The PRU 208 may respond with an advertisement message 508. The advertisement message 508 may be the same or similar to data structure 412, as described in conjunction with FIG. 4B.

Upon receiving the advertisement 508, the PTU 204 and PRU 208 may exchange static and dynamic parameters in one or more messages 512. The static and dynamic parameters 512 may be may be the same or similar to data structure 416, as described in conjunction with FIG. 4C. Upon receiving the static and dynamic parameters 512, the PTU 204 can decide whether to conduct MR charging by sending an accept/reject signal 520 to the PRU 208. The accept/reject signal 520 may be the same or similar to data structure 422, as described in conjunction with FIG. 4D.

The MI mode 552b may begin by the transmission of a digital ping 524, which is sent by the PTU 204 to the PRU 208. The digital ping 524 may be the same or similar to data structure 426, as described in conjunction with FIG. 4E. To respond to the digital ping 524, the PRU 208 may send a modulated power signal 528. The modulated power signal 528 indicates to PTU 204 that the PRU 208 received the digital ping 524 and may desire MI charging. In one or more messages 532, the PTU 204 and PRU 208 may exchange identification and other information, with identification with RXID message(s) 532. These communications 532 may be the same or similar to data structures 434 or 416, as described in conjunction with FIG. 4c or 4F. If MI charging is to occur, the PTU 204 can inform the PRU 208 by sending a validation/accept message 536 to the PRU 208. The validation/accept message 536 may be the same or similar to message 422, as described in conjunction with FIG. 4D.

Methods of Managing Dual Mode Power Transmission:

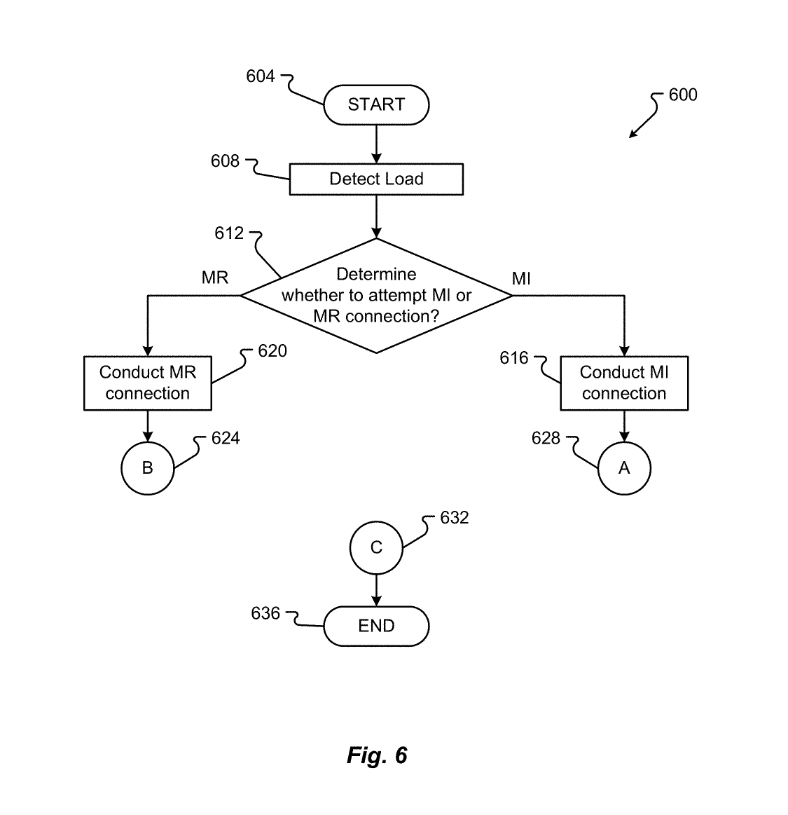

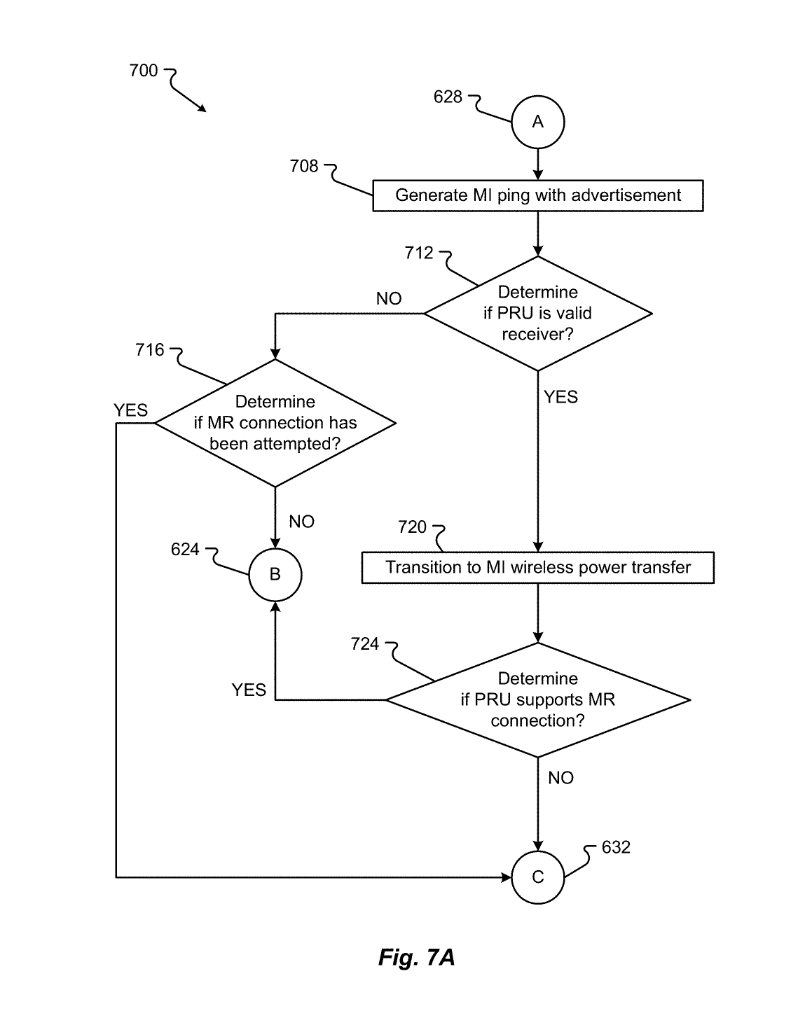

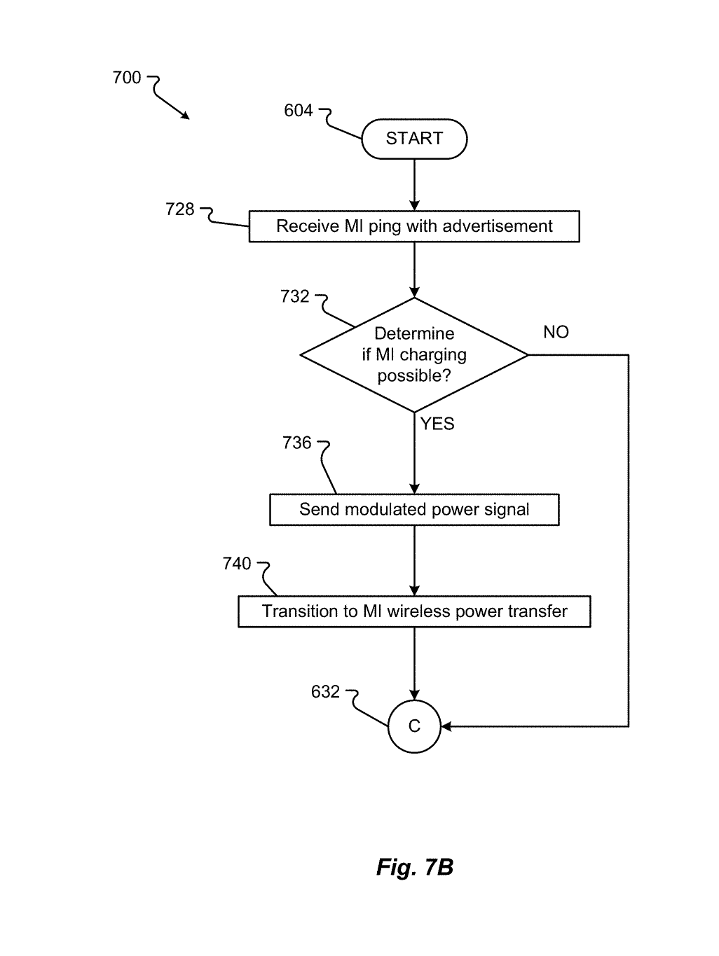

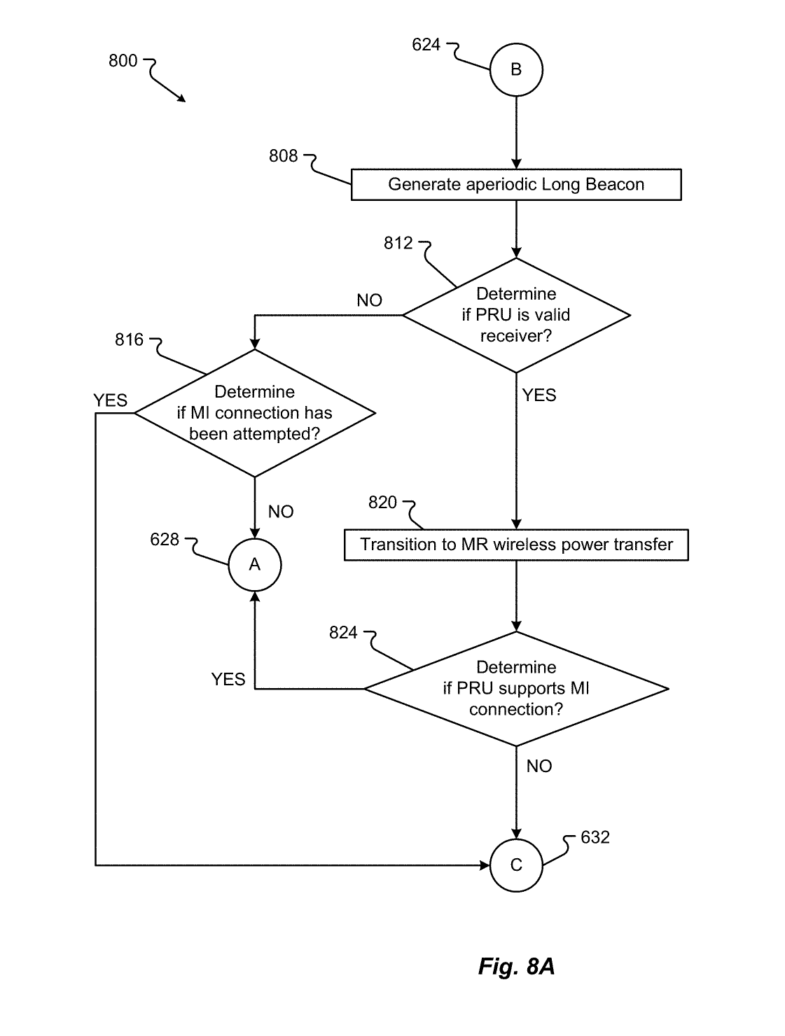

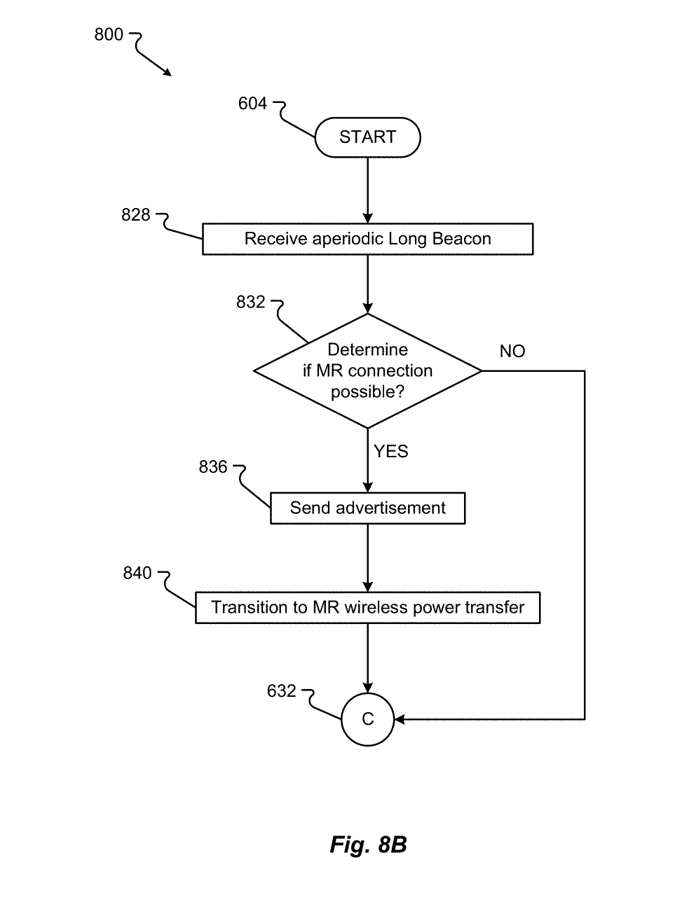

An embodiment of a method, comprising methods 600, 700, and 800, for initiating MR and/or MI wireless charging may be as shown in FIGS. 6-8B. FIGS. 6, 7A and 8A are conducted by the PTU 204. FIGS. 7B and 8B are conducted by the PRU 208. A general order for the steps of the methods 600, 700, 800 are shown in FIGS. 6-8B. Generally, the methods 600, 700, 800 start with a start operation 604 and end with an end operation 636. The methods 600, 700, 800 can include more or fewer steps or can arrange the order of the steps differently than those shown in FIGS. 6-8B. The methods 600, 700, 800 can be executed as a set of computer-executable instructions executed by a computer system or processor and encoded or stored on a computer readable medium. Hereinafter, the methods 600, 700, 800 shall be explained with reference to the systems, components, circuits, modules, software, data structures, etc. described in conjunction with FIGS. 1-5.

The PTU 204 can detect a load, in step 608. In some configurations, while in MR mode, the load detection is done by checking for an impedance shift and/or a presence pulse. While in MI mode, the PTU 204 can monitor changes in the inductance of the system to determine if there is a load. If there is a load detected, the method proceeds to step 612.

In step 612, the PTU 204 can determine whether to accept a MI or MR connection. If a MI connection can be attempted, the method 600 proceeds to step 616. If a MR connection is to be attempted, the method 600 proceeds to step 620. In step 616, the PTU 204 conducts a MI connection. In step 620, the PTU 204 conducts a MR connection. The method 600 continues through off page connector “A” 628, from step 616 to step 708 in method 700, as shown in FIG. 7A.

In step 708, the PTU 204 generates an digital ping. The digital ping may be the same or similar to signal 524, as described in conjunction with FIG. 5. The ping 524 can include a data structure, which may be the same or similar to data structure 426, as described in conjunction with FIG. 4E.

The PTU 204 may then receive and/or retrieve information to determine if the PRU 208 is a valid receiver to conduct MI operations, in step 712. The information may include a type, an identifier, or other information, such as that received in signals 532 or signal 528, as described in conjunction with FIG. 5. These signals can include data structures 416, 434, as described in conjunction with FIGS. 4C and 4F. If it is determined that the PRU 208 is a valid receiver for MI connection, the method 700 proceeds “YES” to step 720. However, if the PRU 208 is not valid, the method 700 proceeds “NO” from step 712 to step 716.

In step 720, the PTU 204 transitions to a MI wireless power transfer mode. The PTU 204 then provides an electromagnetic field for MI charging to the PRU 208. Thereinafter, the PTU 204 may determine if the PRU 208 supports a MR connection, in step 724. If the PRU 208 does support a MR connection, then method 700 proceeds through off page connector “B” 624 to step 808 shown as part of method 800 provided in FIG. 8A. If the PRU 208 does not support a MR connection, the method 700 proceeds “NO” through off page connector “C” 632 back to FIG. 6, where the process 600 ends with end operation 636.

In step 716, the PTU 204 determines if the MR connection has already been attempted. If the MR connection has been attempted, method 700 proceeds “YES” through off page connector “C” 632 where the process 600 ends at end operation 636. If it is determined that a MR connection has not been attempted, then method 700 proceeds “NO” through off page connector “B” 624 to step 808 shown as part of method 800 provided in FIG. 8A.

The steps or processes performed by the PRU 208 in method 700 is shown in FIG. 7B. Here, the PRU 208 may receive, in step 728, the digital ping 524 generated and sent by the PTU, in step 708. Based on the received digital ping 524, the PTU 208 can determine if MI charging is possible and/or desired, in step 732. If the PRU 208 is capable and/or desirous of conducting MI charging, the method 700 proceeds “YES” to step 736. However, if MI charging is not possible and/or not needed, method 700 proceeds “NO” through off page connector “C” 632 where the process 600 terminates with end operation 636.

In step 737, to respond to the digital ping 524, the PRU 208 can send a modulated power signal, in step 736. The modulated power signal may be the same or similar to signal 528, as described in conjunction with FIG. 5. The modulated power signal 528 can indicate to the PTU 204 that the PRU 208 received the digital ping 524 and/or is capable of receiving a MI connection. Thereinafter, and upon receiving the validation accept message 536, the PRU 208 may transition to a MI wireless power transfer state, in step 740. At this transition, the PRU 208 can receive the electromagnetic field produced by the PTU 204 in the MI power mode to energize components of the device 112 and/or to charge the battery associated with the device 112.

Returning to FIG. 6, if a MR connection is to be attempted in step 620, the method 600 proceeds through off page connector 624 to conduct method 800 as shown in FIG. 8A. In method 800, the PTU 204 can generate an aperiodic long beacon, in step 808. The aperiodic long beacon may be similar to or the same as signal 504, as described in conjunction with FIG. 5. The aperiodic long beacon 504 may include data structure 402 as described in conjunction with FIG. 4A.

In response to the aperiodic long beacon 504, the PTU 204 may receive an advertisement signal 508 or other information, such as static and/or dynamic parameters 512, as described in conjunction with FIG. 5. These signals 508, 524 can include data structures 412 and/or 416, as described in conjunction with FIGS. 4B and 4C. Based on the information received or other information retrieved by the PTU 204, the PTU 204 can determine if the PRU 208 is a valid receiver for MR charging, in step 812.

If the PRU 208 is a valid receiver, the method 800 proceeds “YES” to step 820. However, if the PRU 208 is not a valid receiver, the method 800 proceeds “NO” to step 816. In step 820, the PTU 204 can transition to the MR wireless power transfer mode 552a and provide a resonant magnetic field to the PRU 208 for charging. From there, the method 800 proceeds to step 824 where the PTU 204 can determine if the PRU 208 supports a MI connection. If a MI connection is supported, the method 800 proceeds “YES” through off page connector “A” 628 back to step 708 shown in FIG. 7A.

In step 816, if the PRU 208 is not a valid receiver, the PTU 204 can determine if a MI connection has been attempted, in step 816. If a MI connection has not been attempted, the method 800 proceeds “NO” through off page connector “A: 628 back to step 708 shown in FIG. 7A. However, if a connection has been attempted, method 800 proceeds “YES” through off page connector “C” 632 back to end operation 636 shown in FIG. 6.

Method 800 may be conducted from the prospective of the PRU 208 as shown in FIG. 8B. Here, the PRU 208 may receive the aperiodic long beacon, in step 828. That long beacon may be that same as or similar to signal 504, as described in conjunction with FIG. 5. The signal 504 may contain data structure 402 or other information, as described in conjunction with FIG. 4A.

Upon receiving aperiodic long beacon 504, the PRU 208 may determine if a MR connection is possible or desired, in step 832. If the MR connection is possible and/or desired, the method 800 proceeds “YES” to step 836, where the PRU 208 can send an advertisement signal, the same as or similar to signal 508, as described in conjunction with FIG. 5, to the PTU 204. Signal 508 may contain information the same as or similar to data structure 412, as described in conjunction with FIG. 4B. If no MR connection is possible and/or desired, method 800 may proceed “NO” through off page connector “C” 632 to end operation 636 shown in FIG. 6.

After sending the advertisement in step 8736, the PRU 208 may transition to a MR wireless power transfer mode, if provided by the PTU 204, in step 840. Here, the PRU 208 may receive the MR resonant magnetic field to charge components or the battery associated with the PRU 208.

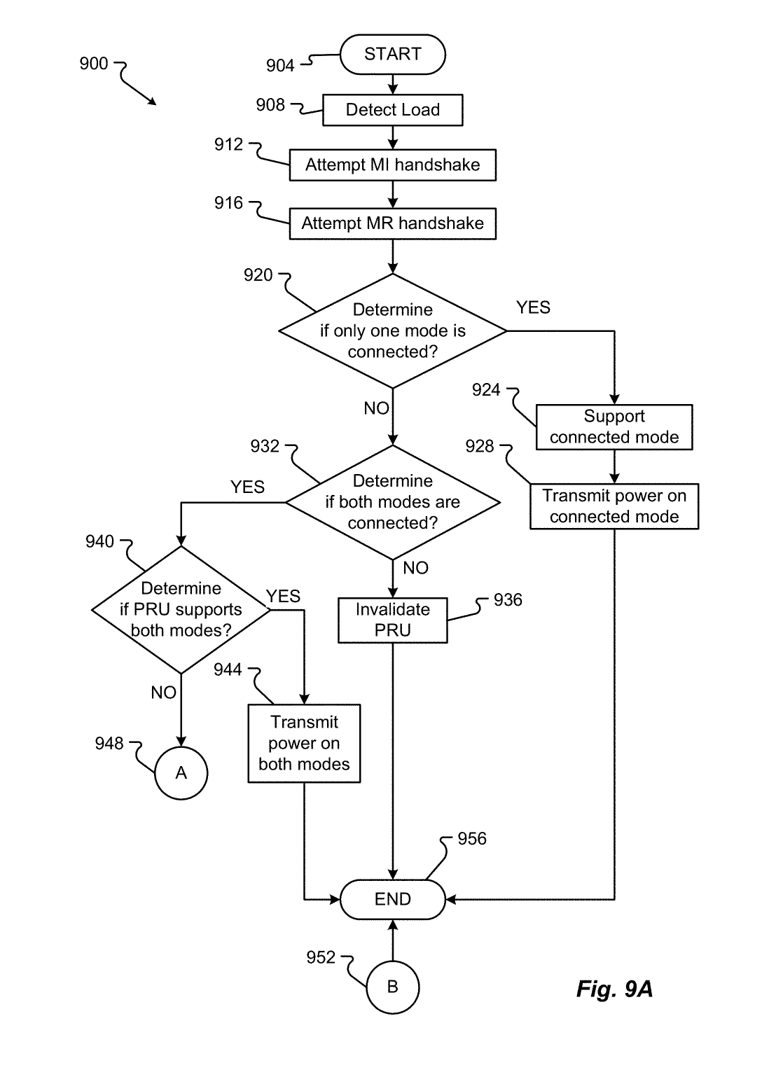

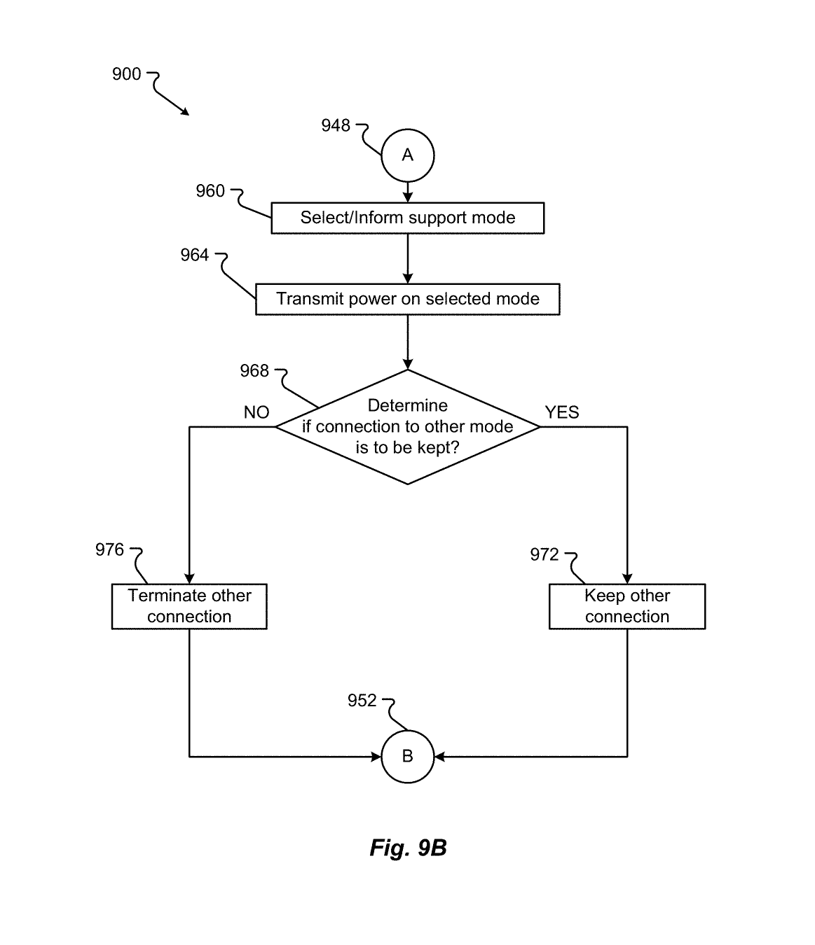

An embodiment of a method 900 for conducting dual mode power transfer through a MI connection and/or a MR connection may be as shown in FIGS. 9A and 9B. A general order for the steps of the method 900 is shown in FIGS. 9A and 9B. Generally, the method 900 starts with a start operation 904 and ends with an end operation 956. The method 900 can include more or fewer steps or can arrange the order of the steps differently than those shown in FIGS. 9A and 9B. The method 900 can be executed as a set of computer-executable instructions executed by a computer system or processor and encoded or stored on a computer readable medium. Hereinafter, the method 900 shall be explained with reference to the systems, components, circuits, modules, software, data structures, etc. described in conjunction with FIGS. 1-5.

The PTU 204 can detect a load, in step 908. The PTU 204 can detect a load, as previously explained with respect to step 608 as described in conjunction with FIG. 6. If a load is detected, the PTU 204 can attempt, in step 912, a MI handshake, as described in conjunction with FIGS. 7A and 7B. Thereinafter, the PTU 204 can attempt, in step 916, a MR handshake, as described in conjunction with FIGS. 8A and 8B. After the handshake(s) is completed, the PTU 204 can determine if only one mode is connected, in step 920. If only one mode is connected, then method 900 may proceed “YES” to step 924; however, if more than one mode is connected, method 900 may proceed “NO” to step 932.

In step 924, the PTU 204 can support the connected mode through information transfer and/or with other operations. Further, the PTU 204 can transmit power on the connected mode, in step 928. Thus, the PTU 204 can provide an electromagnetic signal, either through the MI or MR connection, in step 928.

In step 932, the PTU 204 can determine if both modes are connected. The PTU 204 can determine if both modes are connected based on the handshakes provided in step 912 and 916. If both modes are connected, the method proceeds “YES” to step 940. However, if both modes are not connected, the method proceeds “NO” to step 936 where the PTU 204 determines whether the PRU 208 is invalid. In the situation whether the PRU 208 is invalid, the PTU 204 can invalidate the PRU 208 and may send a reject signal 520, 536 to the PRU 208. The reject signal 520, 536 may have data, which is the same or similar to data structure 422, as described in conjunction with FIG. 4D.

In step 940, the PTU 204 can determine if the PRU 208 supports both modes. If both modes are supported based on the handshakes 912 and 916, the method 900 may proceed “YES” to step 944, where the PTU 204 can transmit power in both modes. In this way, the PTU 204 can charge the PRU 208 through a MI connection and/or a MR connection. It should be noted that the PTU 204 may use both modes simultaneously or transition back and forth between the two modes if both modes are supported. If both modes are not supported, the method 900 may proceed “NO” through off page connector “A” 948 to step 960 shown in FIG. 9B.

The PTU 204 may select which of the modes, MR or MI, is to be used to charge the PRU 208, in step 960. Based on the selection, the PTU 204 may inform the PRU 208 which mode is selected. The information of which mode is selected may be transmitted by the PTU 204 in an accept signal 520 or invalidation/accept signal 536. Based on which signal is sent, the PRU 208 can determine which mode will be used. After selection of the mode and informing the PRU 208, the PTU 204 can transmit power on the selected mode, in step 964.

Thereinafter, the PTU 204 can determine if a connection in the other mode has been made and is to be kept, in step 968. If the connection is to be kept, the method 900 proceeds “YES” to step 972, where the PTU 204 keeps the connection, although power may not be transferred by that connection. If the connection is not to be kept, the method 900 proceeds “NO” to step 976 where the PTU 204 may terminate the connection. The PTU 204 may terminate the connection by sending a reject or other signal 520, which informs the PRU 208 of the termination of that connection. Thereinafter, the method 900 proceeds through off page connector “B” 952 back end operation 956 shown in FIG. 9A.

Mobile Device Architecture:

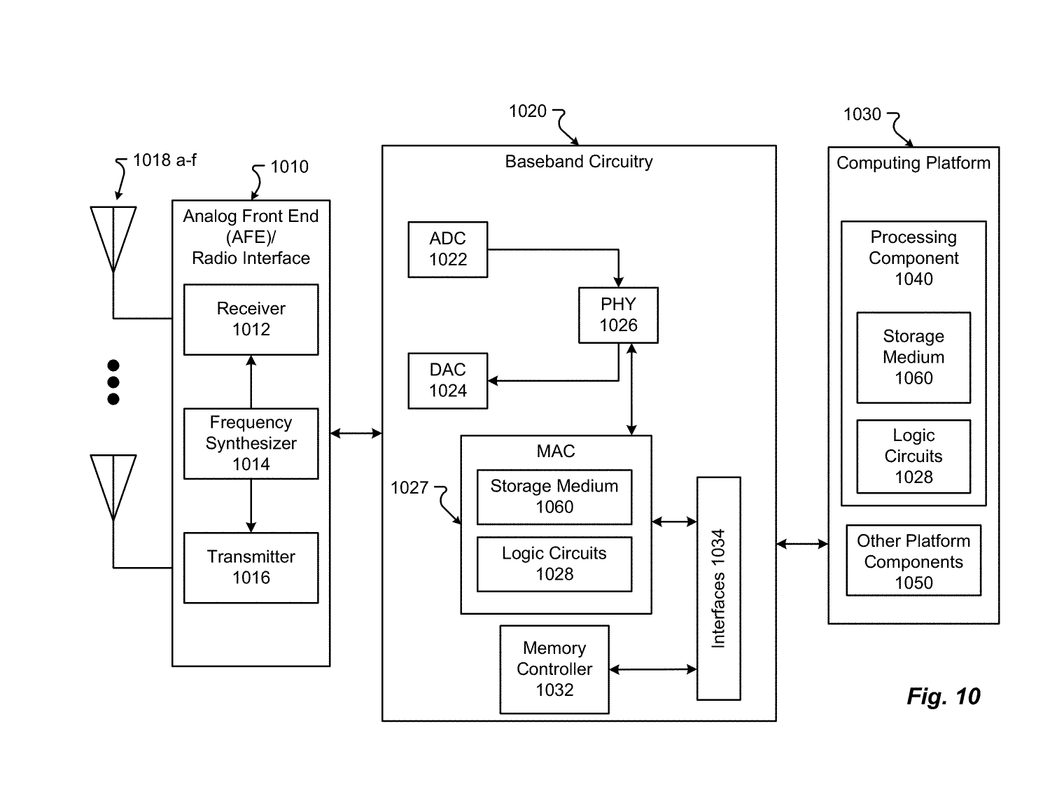

FIG. 10 illustrates an embodiment of a communications device 1000 that may implement one or more devices 112 of FIG. 1. In various embodiments, device 1000 may comprise a logic circuit 1028. The logic circuit 1028 may include physical circuits to perform operations described for one or more devices 112 of FIG. 1, for example. The logic circuit may implement the controller 340. As shown in FIG. 10, device 1000 may include one or more of, but is not limited to, a radio interface 1010, baseband circuitry 1020, and/or computing platform 1030.

The device 1000 may implement some or all of the structure and/or operations for one or more devices 112 of FIG. 1, storage medium 1060, and logic circuit 1028 in a single computing entity, such as entirely within a single device 102. Alternatively, the device 1000 may distribute portions of the structure and/or operations for one or more devices 112 of FIG. 1, storage medium 1060, and logic circuit 1028 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems.

An analog front end (AFE)/radio interface 1010 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the configurations are not limited to any specific over-the-air interface or modulation scheme. AFE/Radio interface 1010 may include, for example, a receiver 1012, a frequency synthesizer 1014, and/or a transmitter 1016. AFE/Radio interface 1010 may include bias controls, a crystal oscillator, and/or one or more antennas 1018-f. In additional or alternative configurations, the AFE/Radio interface 1010 may use external voltage-controlled oscillators (VCOs), surface acoustic wave filters, intermediate frequency (IF) filters and/or RF filters, as desired.

Baseband circuitry 1020 may communicate with AFE/Radio interface 1010 to process, receive, and/or transmit signals and may include, for example, an analog-to-digital converter 1022 for down converting received signals, a digital-to-analog converter 1024 for up converting signals for transmission. Further, baseband circuitry 1020 may include a baseband or physical layer (PHY) processing circuit 1026 for the PHY link layer processing of respective receive/transmit signals. Baseband circuitry 1020 may include, for example, a medium access control (MAC) processing circuit 1027 for MAC/data link layer processing. Baseband circuitry 1020 may include a memory controller 1032 for communicating with MAC processing circuit 1027 and/or a computing platform 1030, for example, via one or more interfaces 1034.

In some configurations, PHY processing circuit 1026 may include a frame construction and/or detection module, in combination with additional circuitry such as a buffer memory, to construct and/or deconstruct communication frames. Alternatively or in addition, MAC processing circuit 1027 may share processing for certain of these functions or perform these processes independent of PHY processing circuit 1026. In some configurations, MAC and PHY processing may be integrated into a single circuit.

The computing platform 1030 may provide computing functionality for the device 1000. As shown, the computing platform 1030 may include a processing component 1040. In addition to, or alternatively of, the baseband circuitry 1020, the device 1000 may execute processing operations or logic for one or more of AP 102 and STAs 104a-104, storage medium 1060, and logic circuit 1028 using the processing component 1040. The processing component 1040 (and/or PHY 1026 and/or MAC 1027) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1030 may further include other platform components 1050. Other platform components 1050 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units 1060 may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1000 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 1000 described herein, may be included or omitted in various embodiments of device 1000, as suitably desired.

Embodiments of device 1000 may be implemented using single input single output (SISO) architectures. However, certain implementations may include multiple antennas (e.g., antennas 1018-f) for transmission and/or reception using adaptive antenna techniques for beamforming or spatial division multiple access (SDMA) and/or using MIMO communication techniques.

The components and features of device 1000 may be implemented using any combination of discrete circuitry, application specific integrated circuits (ASICs), logic gates and/or single chip architectures. Further, the features of device 1000 may be implemented using microcontrollers, programmable logic arrays and/or microprocessors or any combination of the foregoing where suitably appropriate. It is noted that hardware, firmware, and/or software elements may be collectively or individually referred to herein as “logic,” “circuit,” or “processor.”

The device in FIG. 10 can also contain a security module (not shown). This security module can contain information regarding, but not limited to, security parameters required to connect the device to another device or other available networks or network devices, and can include WEP or WPA security access keys, network keys, etc., as discussed.

Another module that the device in FIG. 10 can include is a network access unit (not shown). The network access unit can be used for connecting with another network device. In one example, connectivity can include synchronization between devices. In another example, the network access unit can work as a medium which provides support for communication with other stations. In yet another example, the network access unit can work in conjunction with at least the MAC circuitry 1027. The network access unit can also work and interact with one or more of the modules/components described herein.

It should be appreciated that the exemplary device 1000 shown in the block diagram of FIG. 10 may represent one functionally descriptive example of many potential implementations. Accordingly, division, omission, or inclusion of block functions depicted in the accompanying figures does not infer that the hardware components, circuits, software and/or elements for implementing these functions would be necessarily be divided, omitted, or included in embodiments.

Exemplary aspects are directed toward:

A mobile device comprising:

a coil that receives an AC electromagnetic field at a resonance frequency and converts the AC electromagnetic field into an AC electromagnetic current that powers the mobile device and/or charges a battery of the mobile device;

a master control device (MCD) that controls operations in the mobile device;

a power receiver unit (PRU) electrically coupled to the coil and in communication with the MCD, wherein the PRU comprises:
a resonant receiver circuit that selectively de-tunes to receive less power from a power transmitter unit that generates the AC electromagnetic field; and
a master control unit (MCU) electrically coupled to the resonant receiver circuit, wherein the MCU:
   receives instructions from the MCD to de-tune the resonant receiver circuit; and
   changes the resonant receiver circuit to de-tune from the resonance frequency.

Any one or more of the above aspects, wherein the resonant receiver circuit comprises a first capacitor that tunes the resonant receiver circuit to the resonance frequency.

Any one or more of the above aspects, wherein the resonant receiver circuit comprises a second capacitor that is selectively coupled to the first capacitor to de-tune the resonant receiver circuit from the resonance frequency.

Any one or more of the above aspects, wherein the first capacitor and second capacitor are in parallel configuration in the resonant receiver circuit.

Any one or more of the above aspects, wherein the MCU is electrically coupled to the second capacitor by a first transistor.

Any one or more of the above aspects, wherein the MCU selectively energizes a gate of the first transistor to electrically couple the first capacitor with the second capacitor.

Any one or more of the above aspects, wherein the MCD conducts radio frequency operations through a cellular or wireless modem when the resonant receiver circuit is de-tuned to lower interference caused by receiving a charge at the PRU.

A method for managing power breaks, the method comprising:

a controller of a power receiver unit (PRU) of a mobile device receiving a notification, of an upcoming power break, sent from a power transmitter unit (PTU);

after receiving the notification, the controller of the PRU transitioning to a power break where the PTU lowers a voltage of or eliminates an AC electromagnetic field that charges the PRU, wherein the mobile devices sends or receives data through a cellular modem of the mobile device during the power break;

after transitioning to the power break, the controller of the PRU transitioning back to a normal power mode where the PTU reestablishes a normal AC electromagnetic field that provides a charge in the PRU.

Any one or more of the above aspects, the method further comprises receiving a power break plan, wherein the power break plan comprises one or more of a start time, duration, a frequency/reoccurrence field, a power output field, a number of power breaks, a stop time, and/or a wait time.

Any one or more of the above aspects, the method further comprises sending a power break request to the PTU.

Any one or more of the above aspects, the method further comprises sending a power break request plan to the PTU.

Any one or more of the above aspects, the method further comprises:

the PRU receiving an acknowledgement from the PTU, wherein the PRU sends the acknowledgement if the PRU is capable of receiving the power break.

Any one or more of the above aspects, the method further comprises:

during a normal power mode, the PRU sending a notification that the PRU will transition to absorb less power;

after sending the notification, de-tuning a resonant receiver circuit in the PRU to receive less power from the PTU.

Any one or more of the above aspects, the method further comprises, while the resonant receiver circuit is de-tuned, sending or receiving data with the cellular model of the mobile device.

Any one or more of the above aspects, the method further comprises sending a termination message to inform the PTU that the PRU will begin to return to a normal load.

A non-transitory computer-readable storage media that stores instructions for execution by one or more processors to perform operations for a power receiver unit (PRU) of a mobile device, the instructions comprising:

instructions to receive a notification, of an upcoming power break, sent from a power transmitter unit (PTU);

after receiving the notification, instructions to transition to a power break where the PTU lowers a voltage of or eliminates an AC electromagnetic field that charges the PRU, wherein the mobile devices sends or receives data through a cellular modem of the mobile device during the power break;

after transitioning to the power break, instructions to transition back to a normal power mode where the PTU reestablishes a normal AC electromagnetic field that provides a charge in the PRU.

Any one or more of the above aspects, wherein the instructions further compromise: instructions to receive a power break plan, wherein the power break plan comprises one or more of a start time, duration, a frequency/reoccurrence field, a power output field, a number of power breaks, a stop time, and/or a wait time.

Any one or more of the above aspects, wherein the instructions further compromise: instructions to send a power break request to the PTU.

Any one or more of the above aspects, wherein the instructions further compromise: instructions to send a power break request plan to the PTU.

Any one or more of the above aspects, wherein the instructions further compromise:

instructions to receive an acknowledgement from the PTU, wherein the PRU sends the acknowledgement if the PRU is capable of receiving the power break.

Any one or more of the above aspects, wherein the instructions further compromise:

during a normal power mode, instructions to send a notification that the PRU will transition to absorb less power;

after sending the notification, instructions to de-tune a resonant receiver circuit in the PRU to receive less power from the PTU.

A mobile device for managing power breaks, the mobile device comprising: means for receiving a notification, of an upcoming power break, sent from a power transmitter unit (PTU);

after receiving the notification, means for transitioning to a power break where the PTU lowers a voltage of or eliminates an AC electromagnetic field that charges the PRU, wherein the mobile devices sends or receives data through a cellular modem of the mobile device during the power break;

after transitioning to the power break, means for transitioning back to a normal power mode where the PTU reestablishes a normal AC electromagnetic field that provides a charge in the PRU.

Any one or more of the above aspects, the mobile device further comprises means for receiving a power break plan, wherein the power break plan comprises one or more of a start time, duration, a frequency/reoccurrence field, a power output field, a number of power breaks, a stop time, and/or a wait time.

Any one or more of the above aspects, the mobile device further comprises means for sending a power break request to the PTU.

Any one or more of the above aspects, the mobile device further comprises means for sending a power break request plan to the PTU.

Any one or more of the above aspects, the mobile device further comprises:

means for receiving an acknowledgement from the PTU, wherein the PRU sends the acknowledgement if the PRU is capable of receiving the power break.

Any one or more of the above aspects, the mobile device further comprises:

during a normal power mode, means for sending a notification that the PRU will transition to absorb less power;

after sending the notification, means for de-tuning a resonant receiver circuit in the PRU to receive less power from the PTU.

Any one or more of the above aspects, the mobile device further comprises, while the resonant receiver circuit is de-tuned, means for sending or receiving data with the cellular model of the mobile device.

Any one or more of the above aspects, the mobile device further comprises means for sending a termination message to inform the PTU that the PRU will begin to return to a normal load.

A method for managing power breaks, the method comprising:

a controller of a power transmitter unit (PTU) sending a notification of an upcoming power break to a power receiver unit (PRU) of a mobile device;

after sending the notification, the controller of the PTU transitioning to a power break where the PTU lowers a voltage of or eliminates an AC electromagnetic field that charges the PRU, wherein the mobile device sends or receives data through a cellular modem of the device during the power break;

after transitioning to the power break, the controller of the PTU transitioning back to a normal power mode where the PTU reestablishes a normal AC electromagnetic field that provides a charge in the PRU.

Any one or more of the above aspects, the method further comprises sending a power break plan, wherein the power break plan comprises one or more of a start time, duration, a frequency/reoccurrence field, a power output field, a number of power breaks, a stop time, and/or a wait time.

Any one or more of the above aspects, the method further comprises receiving a power break request from the PRU.

Any one or more of the above aspects, the method further comprises receiving a power break request plan from the PRU.

Any one or more of the above aspects, the method further comprises:

the PTU receiving an acknowledgement from the PRU;

the PTU determining whether the PRU is capable of receiving the power break based on the reception of the acknowledgment.

A charging platform for managing power breaks, the charging platform comprising:

means for sending a notification of an upcoming power break to a power receiver unit (PRU) of a mobile device;

after sending the notification, means for transitioning to a power break where the PTU lowers a voltage of or eliminates an AC electromagnetic field that charges the PRU, wherein the mobile device sends or receives data through a cellular modem of the device during the power break;

after transitioning to the power break, means for transitioning back to a normal power mode where the PTU reestablishes a normal AC electromagnetic field that provides a charge in the PRU.

Any one or more of the above aspects, the charging platform further comprises means for sending a power break plan, wherein the power break plan comprises one or more of a start time, duration, a frequency/reoccurrence field, a power output field, a number of power breaks, a stop time, and/or a wait time.

Any one or more of the above aspects, the charging platform further comprises means for receiving a power break request from the PRU.

Any one or more of the above aspects, the charging platform further comprises means for receiving a power break request plan from the PRU.

Any one or more of the above aspects, the charging platform further comprises:

means for receiving an acknowledgement from the PRU;

means for determining whether the PRU is capable of receiving the power break based on the reception of the acknowledgment.

A non-transitory computer-readable storage media that stores instructions for execution by one or more processors to perform operations for a power transmitter unit (PTU) of a charging platform, the instructions comprising:

instructions to send a notification of an upcoming power break to a power receiver unit (PRU) of a mobile device;

after sending the notification, instructions to transition to a power break where the PTU lowers a voltage of or eliminates an AC electromagnetic field that charges the PRU, wherein the mobile device sends or receives data through a cellular modem of the device during the power break;

after transitioning to the power break, instructions to transition back to a normal power mode where the PTU reestablishes a normal AC electromagnetic field that provides a charge in the PRU.

Any one or more of the above aspects, further comprising instructions to send a power break plan, wherein the power break plan comprises one or more of a start time, duration, a frequency/reoccurrence field, a power output field, a number of power breaks, a stop time, and/or a wait time.

Any one or more of the above aspects, further comprising instructions to receive a power break request from the PRU.

Any one or more of the above aspects, further comprising instructions to receive a power break request plan from the PRU.

Any one or more of the above aspects, further comprising:

instructions to receive an acknowledgement from the PRU;

instructions to determine whether the PRU is capable of receiving the power break based on the reception of the acknowledgment.

A charging platform comprising:

a coil that provides an AC electromagnetic field at a resonance frequency to a second coil associated with a mobile device, wherein the mobile device converts the AC electromagnetic field into an AC electromagnetic current that powers the mobile device and/or charges a battery of the mobile device;

a power transmitter unit (PTU) electrically coupled to the coil, wherein the PTU comprises:

a transmit resonator circuit that generates the AC electromagnetic field; and

a controller electrically coupled to the transmit resonator circuit, wherein the controller:

sends a notification of an upcoming power break to a power receiver unit (PRU) of a mobile device;

after sending the notification, transitions to a power break where the PTU lowers a voltage of or eliminates the AC electromagnetic field that charges the PRU, wherein the mobile device sends or receives data through a cellular modem of the device during the power break;

after transitioning to the power break, transitions back to a normal power mode where the PTU reestablishes a normal AC electromagnetic field that provides a charge in the PRU.

Any one or more of the above aspects, wherein the controller further sends a power break plan, wherein the power break plan comprises one or more of a start time, duration, a frequency/reoccurrence field, a power output field, a number of power breaks, a stop time, and/or a wait time.

Any one or more of the above aspects, wherein the controller further receives a power break request from the PRU.

Any one or more of the above aspects, wherein the controller further receives a power break request plan from the PRU.

Any one or more of the above aspects, wherein the controller further:

receives an acknowledgement from the PRU;

determines whether the PRU is capable of receiving the power break based on the reception of the acknowledgment.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, WiFi, LTE, 4G, Bluetooth®®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors and/or controllers as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA®, or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Provided herein are exemplary systems and methods for full- or half-duplex communications in a wireless device(s). While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A mobile device comprising:
a coil that receives an AC electromagnetic field and converts the AC electromagnetic field into an AC electromagnetic current that powers the mobile device and/or charges a battery of the mobile device;
a power receiver unit (PRU) electrically coupled to the coil, wherein the PRU receives power in at least one of a magnetic induction (MI) mode and/or a magnetic resonance (MR) mode, wherein the PRU comprises:
a controller, wherein the controller:
receives a first signal from a power transmitter unit (PTU) indicating that the PTU can charge the PRU through a MI or a MR connection;
sends a response to the first signal; and
transitions the PRU to receive the charge in either the MI or MR mode through the coil.

2. The mobile device of claim 1, wherein the first signal is an aperiodic long beacon indicating the PTU can charge the PRU in the MR mode.

3. The mobile device of claim 2, wherein the controller further determines if the MR connection is possible and/or desired.

4. The mobile device of claim 3, wherein, if the MR connection is possible and/or desired, the response is an advertisement.

5. The mobile device of claim 1, wherein the first signal is a digital ping indicating the PTU can charge the PRU in the MI mode.

6. The mobile device of claim 5, wherein the controller further determines if the MI connection is possible and/or desired.

7. The mobile device of claim 6, wherein, if the MI connection is possible and/or desired, the response is a modulated power signal.

8. A method for managing wireless charging in dual modes, the method comprising:
a controller of a power transmitter unit (PTU) detecting a load associated with a power receiver unit (PRU) of a mobile device;
in response to detecting the load, the controller attempting a magnetic induction (MI) connection;
in response to detecting the load, the controller attempting a magnetic resonance (MR) connection; and
based on the attempt at the MI connection and/or the MR connection, supporting power transfer to the PRU with the MI connection, the MR connection, or both the MI and MR connection.

9. The method of claim 8, wherein the MI handshake comprises:
the controller of the PTU sending a digital ping indicating the PTU can charge the PRU in the MI mode; and
after sending the digital ping, the controller of the PTU receiving a modulated power signal, from the PRU, in response to the digital ping.

10. The method of claim 8, wherein the MR handshake comprises:
the controller of the PTU sending an aperiodic long beacon indicating the PTU can charge the PRU in the MR mode; and
after sending the aperiodic long beacon, the controller of the PTU receiving an advertisement, from the PRU, in response to the aperiodic long beacon.

11. The method of claim 10, further comprising:
based on the attempt at the MI connection and/or the MR connection, determining if only one of the MI mode or MR mode is connected;
if only one of the MI mode or MR mode is connected, transmitting power on the connected mode.

12. The method of claim 9, further comprising:
if only one of the MI mode or MR mode is not connected, the controller of the PTU determining if both the MI mode and the MR mode are connected;
if both the MI mode and the MR mode are not connected, the controller of the PTU invalidating the PRU;
if both the MI mode and the MR mode are connected, the controller of the PTU determining if the PRU supports both the MI mode and the MR mode; and
if the PRU supports both the MI mode and the MR mode, the PTU transmitting power on both the MI mode and the MR mode.

13. The method of claim 12, wherein the PTU transmits power on both the MI mode and the MR mode simultaneously.

14. The method of claim 12, wherein the PTU transmits power on both the MI mode and the MR mode alternatively.

15. The method of claim 12, further comprising:
if the PRU does not support both the MI mode and the MR mode, the controller of the PTU selecting which of the MI mode or the MR mode to support; and
transmitting power on the selected mode.

16. The method of claim 15, further comprising:
the controller of the PTU determining if the MI mode or MR mode not selected should be kept; and
if the MI mode or MR mode not selected is not to be kept, the controller of the PTU terminating the MI mode or MR mode that is not to be kept.

17. A wireless charging platform comprising:
a coil that provides an AC electromagnetic field to charge a power receiver unit (PRU) of a mobile device;
a power transmitter unit (PTU) electrically coupled to the coil, wherein the PTU provides power in at least one of a magnetic induction (MI) mode and/or a magnetic resonance (MR) mode, wherein the PTU comprises:
a controller, wherein the controller:
detects a load associated with the PRU of the mobile device;
in response to detecting the load, attempts a magnetic induction (MI) connection;
in response to detecting the load, attempts a magnetic resonance (MR) connection; and
based on the attempt at the MI connection and/or the MR connection, supports power transfer to the PRU with the MI connection, the MR connection, or both the MI and MR connection.

18. The wireless charging platform of claim 17, wherein the MI handshake comprises:
the controller sends a digital ping indicating the PTU can charge the PRU in the MI mode; and
after sending the digital ping, the controller receives a modulated power signal, from the PRU, in response to the digital ping.

19. The wireless charging platform of claim 17, wherein the MR handshake comprises:
the controller sends an aperiodic long beacon indicating the PTU can charge the PRU in the MR mode; and
after sending the aperiodic long beacon, the controller receives an advertisement, from the PRU, in response to the aperiodic long beacon.

20. The wireless charging platform of claim 17, wherein the controller of the PTU further:
if only one of the MI mode or MR mode is not connected, determines if both the MI mode and the MR mode are connected;
if both the MI mode and the MR mode are not connected, invalidates the PRU;
if both the MI mode and the MR mode are connected, determines if the PRU supports both the MI mode and the MR mode;
if the PRU supports both the MI mode and the MR mode, the PTU transmits power on both the MI mode and the MR mode, wherein the PTU transmits power either simultaneously or alternatively on both the MI mode and the MR mode;
if the PRU does not support both the MI mode and the MR mode, selects which of the MI mode or the MR mode to support;
based on the selection, transmits power on the selected mode.
determines if the MI mode or MR mode not selected should be kept; and
if the MI mode or MR mode not selected is not to be kept, terminates the MI mode or MR mode that is not to be kept.
